(19) United States
(12) Patent Application Publication
(10) Pub. No.: US 2007/0157955 A1
(43) Pub. Date: Jul. 12, 2007

(54) Fresh produce washing and disinfecting apparatus and its ozone concentration detecting apparatus

(76) Inventor: Chih Wen Lin, PanChiao City (TW)

Correspondence Address: RABIN & Berdo, PC, 1101 14TH STREET, NW, SUITE 500, WASHINGTON, DC, 20005, US

(21) Appl. No.: 11/326,426

(22) Filed: Jan. 6, 2006

(51) Int. Cl. B08B 3/00

(52) U.S. Cl. 134/94.1; 134/56 R; 134/113

(57) ABSTRACT

A fresh produce washing and disinfecting apparatus comprises a housing and a basket for containing vegetables and fruits, wherein the housing has a lid, a containing space, a washing turntable, a driving motor, an ozone generator module, and a control circuit. The driving motor is connected to a washing turntable, and the ozone generator module is connected to an air stone by a duct, such that the ozone can decompose the remaining insecticide and disinfect germs, and the control circuit detects the ozone concentration, and the output end of the ozone generator module has a concentration detector coupled to a detect circuit. If ozone exits from the ozone generator module, the concentration detector will detect the ozone concentration and send a concentration signal to the detect circuit for controlling ozone and maintaining its concentration, and further complies with the standard of using ozone for disinfecting and purifying water.

### BACKGROUND OF THE INVENTION

1) Field of the Invention

The present invention relates to a fresh produce washing and disinfecting apparatus and its ozone concentration detecting apparatus primarily for decomposing the insecticide remained on the fresh produce and providing washing and disinfecting effects, such that consumers can eat the fresh produce in a more convenient manner without worrying about contaminations to the fresh produces, and the ozone concentration detecting apparatus installed in the fresh produce washing and disinfecting apparatus can detect and control the ozone concentration to maintain the concentration of the produced ozone and meet the standard of using ozone for the disinfecting and water purifying functions.

2) Description of the Prior Art

Most fresh produces sold in the market have a large quantity of insecticides remained on them. Although consumers notice this fact and usually wash the fresh produce, yet some leaf vegetables or fruits such as strawberries and grapes are very uneasy to wash and clean. Therefore, finding a way to decompose and wash the insecticide remained on fresh produces and to maximize the disinfecting effect so that consumers can eat the fresh produces more conveniently without worrying about contaminations or germs is the main subject of the present invention.

Further, it is common to use an ozone device to achieve the disinfecting and water purifying effects. For example, some products such as refrigerators and washing machines use ozone for handling disinfections, some drinking water machines or water purifying machines also ozone for disinfecting and purifying water, and some aquariums use ozone for purifying water. The disinfecting effect provided by ozone is obvious to all of us. However, an ozone device usually does not come with a detector, and thus once the ozone device has damages of a high-voltage circuit or an ozone generator, ozone with a normal concentration cannot be supplied. Although the pump may be still pumping, only air or ozone of insufficient concentration is supplied. The damage could be very serious, since users continue using the ozone device without knowing its failure, and this becomes a main subject of the present invention.

Further, an ozone device comprises the major components: a pump, a high-voltage circuit, and an ozone generator, wherein the life of the pump is longer and has a function of pumping the ozone. If the pump fails, it will not pump or there will be no air or ozone produced at its output end, and users will be unable to recognize the situation easily. If the high-voltage circuit or ozone generator is damaged, users have no way to know the situation easily. In fact, the high-voltage circuit or ozone generator is a consuming material similar to a filter of a water filter that requires replacements from time to time, but general consumers have no idea about the situation or lack of such knowledge. In general, manufacturers do not actively inform consumers, and thus users do not know when the ozone device fails, or which component fails first, and this becomes another subject of the present invention.

### OBJECTIVES OF THE INVENTION

In view of the foregoing shortcomings of the prior art, the inventor of the present invention based on years of experience to conduct extensive researches and experiments, and finally invented a novel feasible “fresh produce washing and disinfecting apparatus and its ozone concentration detecting apparatus” in accordance with the present invention. Therefore, it is a primary objective of the present invention to maximize the disinfecting effect of the ozone, in hope of fully overcoming the washing and disinfecting issues of fresh produces, so that users can eat contamination-free and germ-free fresh produces more conveniently.

Another objective of the present invention to provide an ozone concentration detecting apparatus that installs an ozone concentration detecting apparatus in the ozone device, users can know about the conditions of its normal operation or its damage that require maintenance, repair, or replacement and thus the invention can effectively control the effect of using ozone for disinfecting or purifying water.

A further objective of the present invention is to provide a novel improved internal glass tube structure, more particularly an internal glass tube structure that is used in an ozone generator module.

### SUMMARY OF THE INVENTION

A fresh produce washing and disinfecting apparatus of the present invention comprises a cylindrical housing and a fresh produce basket for containing fresh produces such as vegetables and fruits, wherein the housing has a lid at its top for putting in or taking out the fresh produce basket by lifting the lid, and the lid has a fresh water inlet at its internal side for filling in fresh water, and the housing at its middle portion has a containing space for placing the fresh produce basket, and the bottom of the containing space has a washing turntable and a water outlet for discharging water, and the washing turntable is provided for producing water whirls in the containing space, so that the whirls can sanitize chemical precipitates remained after the decomposition of the insecticides, and both sides of the washing turntable have two air stones, and another end of the air stone is connected to an ozone generator module. Further, the housing at its bottom includes a driving motor, an ozone generator module, and a control circuit, wherein the driving motor is connected to the washing turntable, and the ozone generator module is connected to the air stone by a duct. The ozone can decompose or disinfect the remaining insecticide of the fresh produce, and the control circuit is provided for detecting the ozone concentration and controlling the operations of the present invention. The foregoing fresh produce washing and disinfecting apparatus can fully decompose the remaining insecticide of fresh produces and achieve the disinfecting function. In the meantime, the fresh produce washing and disinfecting apparatus also has a function of washing chemical precipitates again, so that users can eat fresh produces more conveniently without worrying about possible contaminations and germs of vegetables and fruits.

The ozone concentration detecting apparatus of the invention comprises: a pump, a high-voltage circuit, an ozone generator module, a detect circuit, and a concentration detector, wherein the output end of the ozone generator module includes the concentration detector, and the concentration detector is connected to the detect circuit. If the ozone exits from the ozone generator module, the ozone will be detected by the concentration detector, and a detected concentration signal will be sent to the detect circuit for controlling the ozone and maintaining the concentration of produced ozone, so that the ozone can meet the standard for the disinfecting and water purifying functions.

The ozone concentration detecting apparatus includes an internal glass tube in the ozone generator module, and a metal pipe is placed into the internal glass tube first, and a washer is attached closely onto the internal wall of the internal glass tube, and a transmitting medium in a powder form is filled between the metal pipe and the internal glass tube. The transmitting medium is made of an anti-oxidant material, and a stopper having a spring and a conducting rod is plugged into the internal glass tube, so that the spring and the metal pipe are contacted to define a conductor, and finally the conducting rod is connected to an anode of the high-voltage circuit, while a conducting wire is connected to a cathode of the high-voltage circuit to produce ozone with a high concentration steadily for the disinfecting or water purifying effects.

### BRIEF DESCRIPTION OF THE DRAWINGS

FIG. 1 is a perspective view of the present invention;

FIG. 2 is a cross-sectional view of a housing of the present invention;

FIG. 3 is a top view of a housing of the present invention;

FIG. 4 is a view of a plain layout of an ozone concentration detecting apparatus of the present invention;

FIG. 5 is a cross-sectional view of an ozone generator module of the present invention;

FIG. 6 is a cross-sectional view of an internal glass tube of a prior art; and

FIG. 7 is a cross-sectional view of an internal glass tube of the present invention.

### DETAILED DESCRIPTION OF THE PREFERRED EMBODIMENTS

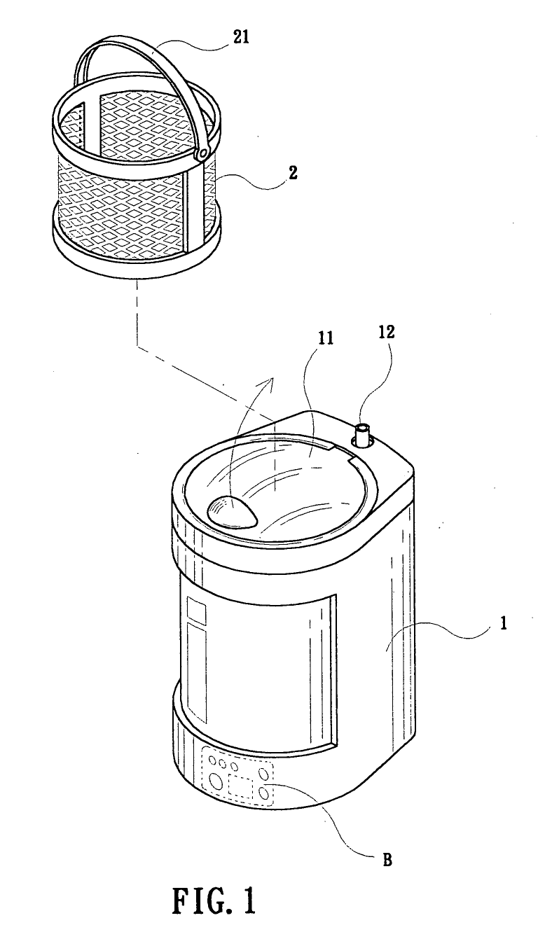

Referring to FIG. 1, a fresh produce washing and disinfecting apparatus of the invention comprises a cylindrical housing 1 and a fresh produce basket 2 for containing fresh produces such as vegetables and fruits, wherein the fresh produce basket 2 is a container that can be submerged into water for containing vegetables and fruits, and the fresh produce basket 2 has a handle 21 for facilitating users to hold in order to put in or take out the housing 1.

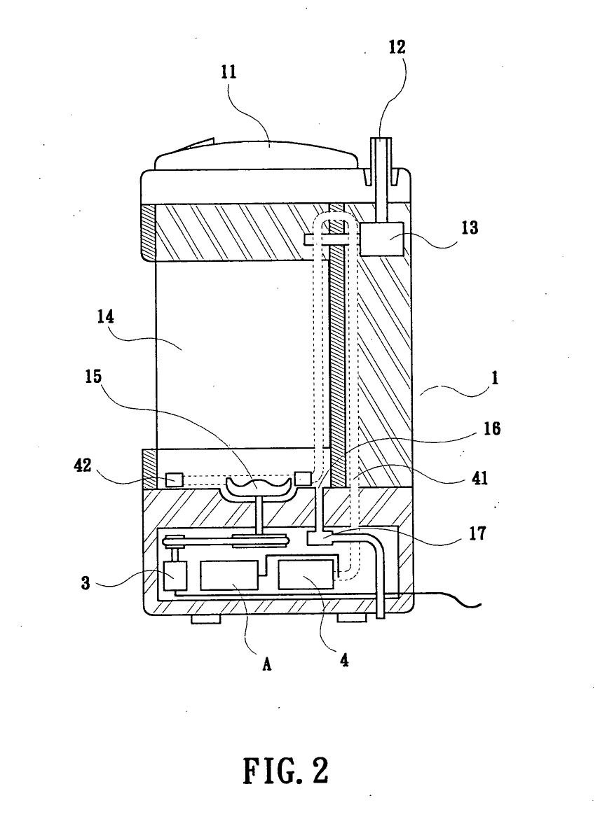

The housing 1 at its top has a lid 11, and the lid 11 can be lifted to put in or take out the fresh produce basket 2, and the internal side of the lid 11 has a fresh water inlet 12 for filling in fresh water, and the fresh water inlet 12 includes a water-filling solenoid valve 13. Referring to FIG. 2, the water-filling solenoid valve 13 is provided for controlling the timing of filling in the fresh water.

The housing 1 at its middle portion includes a containing space 14 for disposing the fresh produce basket 2, and center of the bottom of the containing space 14 has a washing turntable 15 for producing water whirls in the containing space 14, and both sides of the washing turntable 15 include two air stones 42, and the other end of the air stone 42 is connected to an ozone generator module 4, and the bottom of the containing space 14 has a water outlet 16, and the water outlet 16 has a drainage solenoid valve 17 for controlling the timing of discharging water.

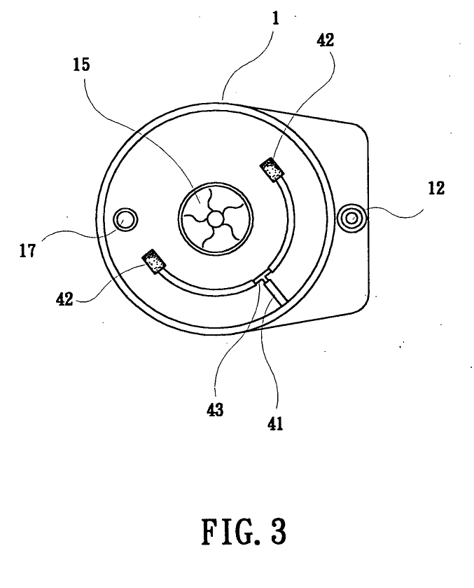

The bottom of the housing 1 includes a driving motor 3, an ozone generator module 4, and a control circuit A, wherein the driving motor 3 is connected to the washing turntable 15, and the ozone generator module 4 is connected to the air stone 42 by a duct 41, so that the ozone is produced for decomposing the insecticide remained on the fresh produce and achieving the disinfecting effect. Referring to FIG. 3, the air stone 42 is fixed by a T-shape pipe 43, wherein the quantity of air stones 42 can be changed according to the capacity of ozone, and the control circuit A is provided for detecting the ozone concentration and controlling the operations of the present invention.

The housing 1 has a control panel B installed at an appropriate position as shown in FIG. 1, and the control panel B can be operated for controlling the timing of filling and discharging water, selecting a regular level or a high level of water depending on the quantity of vegetables and fruits, and setting the time for the ozone to decompose the remaining insecticide and disinfect according to the types of fresh produces. Meanwhile, the control panel B can be operated for detecting the ozone concentration and acting as a warning circuit if the detected ozone concentration is below a safety concentration, so as to inform users and protect user's safety.

The control and operating flow of the present invention are described below:

(1) Firstly, put the fresh produces bought from a market (or the desired vegetables and fruits for washing and disinfecting) into the fresh produce basket 2.

(2) Lift up the lid 111 of the housing 1 and put the fresh produce basket 2 containing the fresh produces into the containing space 14 of the housing 1, and then cover the lid 11.

(3) Set the disinfecting time on the control panel B (generally set to approximately 15˜30 minutes) and turn on the switch after water is filled up to the set water level.

(4) Fresh water is filled into the containing space 14 of the housing 1 while the ozone generator module 4 delays starting, and the ozone is sent to the air stones 42 through the duct 41. The ozone is inputted to start decomposing the remaining insecticide and carrying out the disinfection.

(5) Until the set disinfecting time of the ozone is reached, the ozone generator module 4 stops operating and discharges water. After the water in the containing space 14 is fully discharged, the first step of the washing and cleaning operations is completed.

(6) After the first stage of washing and disinfecting operations, the chemical precipitates remained on the vegetables and fruits are decomposed, and thus the process will go to the second stage for the washing task.

(7) In the second stage for the washing task, fresh water is also filled into the containing space 14 of the housing 1 first.

(8) After the fresh water is filled up to a set water level, the driving motor 3 starts running to drive the washing turntable 15 to rotate. After the washing turntable 15 is rotated, water whirls will be produced for washing and purifying the remained chemical precipitates.

(9) After the time set for washing and purifying is reached, the driving motor 3 will stop running and thus the washing turntable 15 will stop turning as well. The water discharge operation is performed. After the water in the containing space 14 is fully discharged, the whole process of washing and disinfecting fresh produces is completed.

(10) Finally, the fresh produce basket 2 is taken out, and the vegetables and fruits in the fresh produce basket 2 can be eaten or cooked at ease.

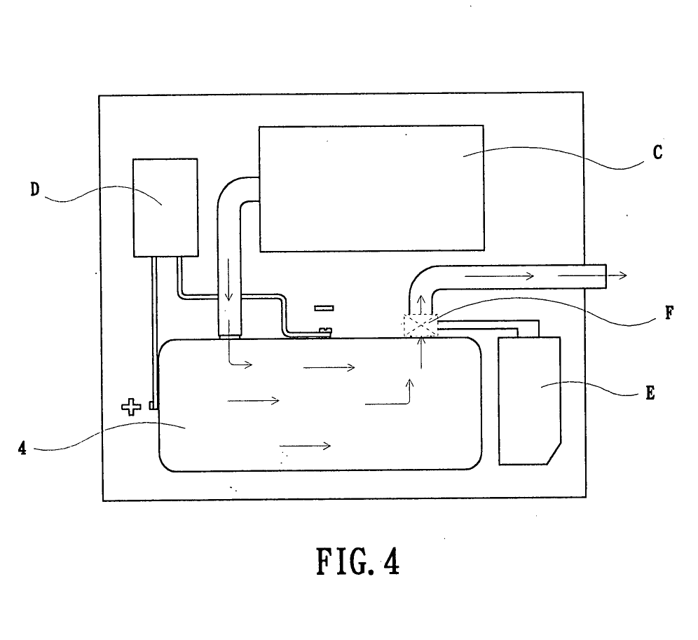

Referring to FIG. 4, the ozone concentration detecting apparatus of the invention comprises a pump C, a high-voltage circuit D, an ozone generator module 4, a detect circuit E, and a concentration detector F, and the output end of the ozone generator module 4 has a concentration detector F, and the concentration detector F is connected to the detect circuit E. If ozone exits from the ozone generator module 4, the ozone will be detected by the concentration detector F, and a detected concentration signal will be sent to the detect circuit E to achieve the purpose of controlling the ozone and maintain the concentration of the produced ozone, so as to meet the standard of using ozone to achieve the disinfecting and water purifying effects.

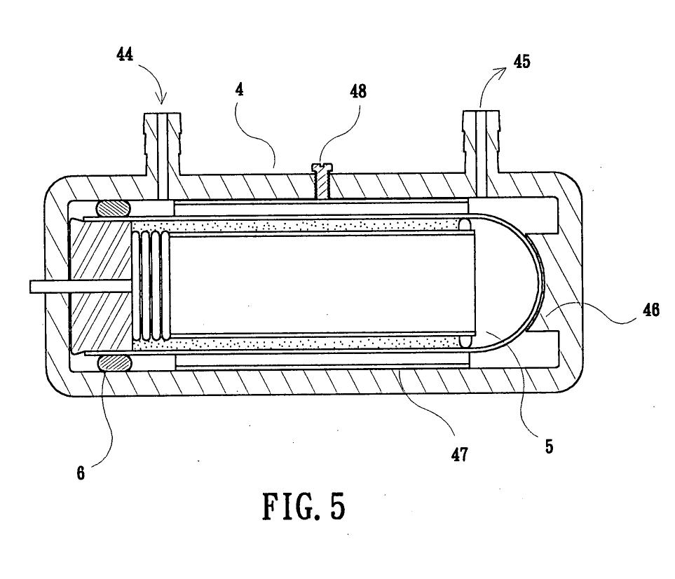

The present invention uses the detected result of the concentration detector F for controlling the state of producing ozone by the monitoring of the detect circuit E. The state of producing ozone depends on the ozone generator module 4, and thus a good ozone generator module 4 not only can stabilize the concentration of the produced ozone, but also can improve its life of use. Therefore, the ozone generator module 4 of the invention provides a breakthrough of its improvement. Referring to FIG. 5, the ozone generator module 4 includes an internal glass tube 5 therein, and the structure of the internal glass tube 5 will be described in details below. The internal glass tube 5 is attached closely onto the internal wall of the ozone generator module 4 by a washer 6. The washer 6 can be used for fixing, and also can achieve an anti-leaking effect.

The ozone generator module 4 includes an air inlet 44 and an ozone outlet 45 thereon, and the ozone generator module 4 includes a retaining base 46 therein for retaining and fixing the internal glass tube 5.

A metal pipe 47 is installed on an internal wall of the ozone generator module 4 and disposed at a maximum valid distance between the air inlet 44 and the ozone outlet 45. After the metal pipe 47 is connected by a screw 48, the conducting wire is connected to the cathode of the high-voltage circuit D, so that a high-voltage surge of the high-voltage circuit D will produce a corona in the ozone generator module 4 to activate the production of ozone.

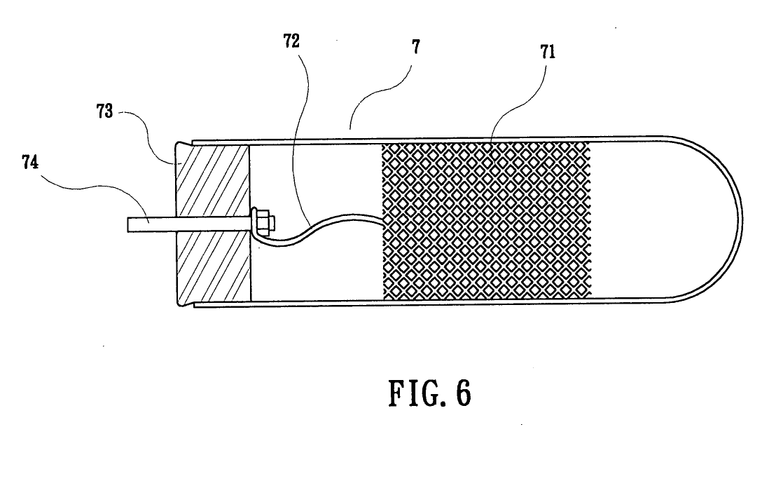

Referring to FIG. 6 for the structure of a prior art internal glass tube 7, the internal glass tube 7 comprises a circular metal net 71, and the circular metal net 71 is connected to a stopper 73 in the conducting rod 74 by a conducting wire 72, and thus the structure is very simple, and the metal net 71 may be oxidized easily to lose its originally intended function. In other words, ozone cannot be produced effectively within a short time period, and the ozone concentration will drop without being noticed.

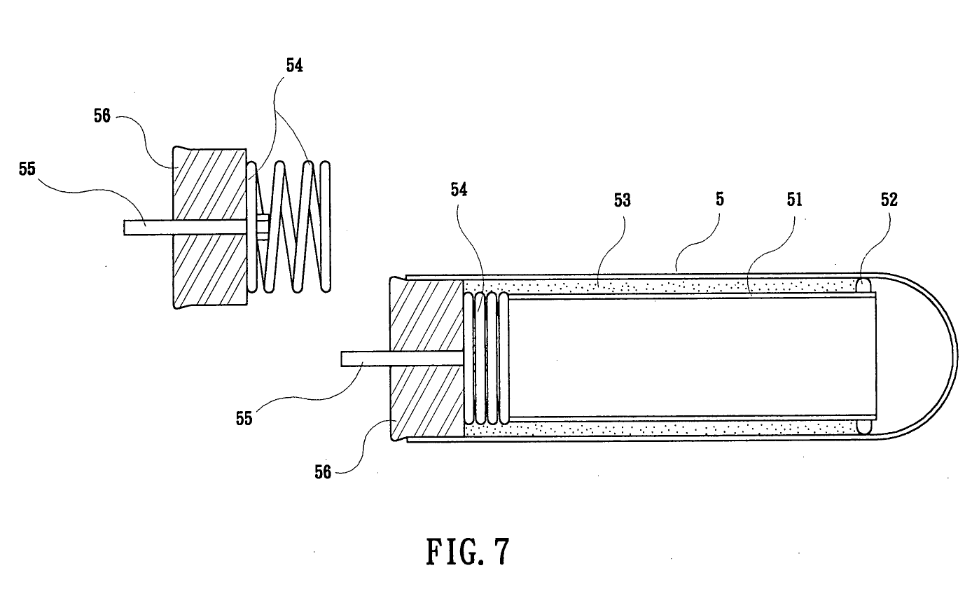

To effectively produce ozone in long hours and meet the production standard, the inventor of the present invention conducted extensive researches and finally developed the structure of an internal glass tube 5 that can reduce oxidation and improve the life of use, and such structure is also the internal glass tube 5 in the foregoing ozone generator module 4. Referring to FIG. 7, the internal glass tube 5 installs a metal pipe 51 therein first, and a washer 52 is attached closely onto an internal wall of the internal glass tube 5, and then a transmitting medium 53 in a powder form is filled between the metal pipe 51 and the internal glass tube 5. The transmitting medium 53 is made of an anti-oxidant material, and finally the stopper 56 having a spring 54 and a conducting rod 55 is plugged into the internal glass tube 5, so that the spring 54 and the metal pipe 51 are contacted to define a conductor. Then, the conducting rod 55 is connected to the anode of the high-voltage circuit D, while the conducting wire is connected to the cathode of the high-voltage circuit D as shown in FIG. 5 for the use of the disinfecting and water purifying purposes.

While the invention has been described by means of specific embodiments, numerous modifications and variations could be made thereto by those skilled in the art without departing from the scope and spirit of the invention set forth in the claims.

What is claimed is:

1. A fresh produce washing and disinfecting apparatus and its ozone concentration detecting apparatus, comprise a cylindrical housing and a fresh produce basket for containing vegetables and fruits, wherein said housing at its top has a lid for putting in or taking out said fresh produce basket, and said lid at its internal side has a fresh water inlet, and said housing at its middle portion has a containing space, and the bottom of said containing space has a washing turntable for producing whirls and a water outlet, and both sides of said washing turntable have two air stones, and another end of said air stone is coupled to an ozone generator module, and said housing at its bottom includes a driving motor, an ozone generator module, and a control circuit, wherein said driving motor is coupled to said washing turntable, and said ozone generator module is coupled to said air stone by a duct, such that the production of ozone can achieve the effects of decomposing the remaining insecticide of said fresh produces and disinfecting, and said control circuit is provided for detecting the concentration of ozone and controlling the operations of said foregoing components, so that said fresh produce washing and disinfecting apparatus can achieve the functions of fully decomposing the remaining insecticide of said fresh produce and disinfecting, as well as providing an effect of washing chemical precipitates again, and thus users can eat fresh produces more conveniently without worrying about the contaminations and germs of said fresh produce.

2. The fresh produce washing and disinfecting apparatus and its ozone concentration detecting apparatus of claim 1, wherein said ozone generator module includes an ozone concentration detecting apparatus, and said ozone concentration detecting apparatus comprises a pump, a high-voltage circuit, an ozone generator module, a detect circuit, and a concentration detector, and an output end of said ozone generator module includes a concentration detector coupled to said detect circuit, such that if ozone exits from said ozone generator module, the ozone will be detected by said concentration detector, and a detected concentration signal will be sent to said detect circuit for controlling the concentration of ozone and meeting the standard for using ozone to achieve the disinfecting and water purifying functions.

3. The fresh produce washing and disinfecting apparatus and its ozone concentration detecting apparatus of claim 1, wherein said ozone generator module includes an internal glass tube therein, and the structure of said internal glass tube comprises a metal pipe installed in said internal glass tube, a washer attached closely onto the internal wall of said internal glass tube, and a transmitting medium in a powder form disposed at a gap between said metal pipe and said internal glass tube, and said transmitting medium is made of an anti-oxidant material, and a stopper having a spring and a conducting rod is plugged into said internal glass tube, such that said spring and said metal pipe are contacted to define a conductor, and then said conducting rod is coupled to the anode of said high-voltage circuit while a conducting wire is coupled to the cathode of said high-voltage circuit for producing high-concentration ozone steadily for the disinfecting and water purifying purposes.

4. The fresh produce washing and disinfecting apparatus and its ozone concentration detecting apparatus of claim 2, wherein said ozone generator module includes an internal glass tube therein, and the structure of said internal glass tube comprises a metal pipe installed in said internal glass tube, a washer attached closely onto the internal wall of said internal glass tube, and a transmitting medium in a powder form disposed at a gap between said metal pipe and said internal glass tube, and said transmitting medium is made of an anti-oxidant material, and a stopper having a spring and a conducting rod is plugged into said internal glass tube, such that said spring and said metal pipe are contacted to define a conductor, and then said conducting rod is coupled to the anode of said high-voltage circuit while a conducting wire is coupled to the cathode of said high-voltage circuit for producing high-concentration ozone steadily for the disinfecting and water purifying purposes.
